(19) United States
(12) Patent Application Publication
(10) Pub. No.: US 2005/0225452 A1
(43) Pub. Date: Oct. 13, 2005

(54) Indicator apparatus and method for a vehicle using side-emitting light-emitting diode

(76) Inventors: Newel L. Stephens, Madison, IN (US); Kevin S. Williams, Hanover, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/815,595

(22) Filed: Apr. 1, 2004

(51) Int. Cl. G08B 5/22

(52) U.S. Cl. 340/815.45; 340/468; 340/463

(57) ABSTRACT

An indicator is provided that utilizes a side-emitting light-emitting diode to indicate the state of a vehicle. An example vehicle indicator is an automobile turn indicator. Other embodiments and features further provide for a conventional light-emitting diode additionally mounted to the vehicle indicator. Certain embodiments provide a cover that protects the vehicle indicator from damage and influences the pattern and/or frequency of light emanating from the vehicle indicator. Yet other embodiments provide a circuit board for converting power from the vehicle's power source to the particular power requirements, a timing mechanism for controlling illumination, and a heat dissipating apparatus for controlling the temperature of the side-emitting light-emitting diode.

### FIELD OF THE INVENTION

This invention relates generally to a vehicle indicator and more particularly to an apparatus and method for indicating the state of a vehicle utilizing side-emitting light-emitting diodes.

### BACKGROUND OF THE INVENTION

Typically, regulations and guidelines for vehicle indicators require minimum light intensity patterns, as measured at various locations around the vehicle indicator to ensure the indicator is visible to other vehicle operators. Incandescent lamps are commonly utilized for vehicle indicators when broad photometric patterns are desired to comply with regulations or other particular design requirements. However, incandescent lamps are susceptible to vibration damage, have a bright filament spot that is not aesthetically desirable, generate large amounts of heat, and emit light over a broad spectrum including frequencies not desirable for certain applications. Typically, light emitting diodes are less susceptible to vibration damage, emit uniform intensity light that is more aesthetically desirable, generate less heat, and are capable of emitting light over a narrower spectrum than incandescent lamps. However, light emitting diodes do not generally emit light in the broad photometric patterns that are required for certain vehicle indicator application, such as, for example, side-mounted turn signals.

A need exists for an improved vehicle indicator that meets photometric requirements, is aesthetically desirable, capable of emiting light over a relatively narrow frequency range, is resistant to vibration damage, reduces the amount of heat generated, and minimizes power requirements over typical incandescent lamps. Certain features of the present invention address these and other needs and provide other important advantages.

### SUMMARY OF THE INVENTION

Embodiments of the present invention provide an indicator that is mountable to a vehicle. Embodiments and features provide for a vehicle indicator that is mountable to a vehicle and capable of indicating the vehicle's state. The vehicle's state includes the vehicle's present, intended, or future position, movement, speed, or acceleration, or any combination thereof. Embodiments of the present invention utilize side-emitting light-emitting diodes, which may be used in conjunction with reflectors, lenses and/or traditional light-emitting diodes.

It is an object of certain embodiments to provide a vehicle indicator with side-emitting light-emitting diodes.

It is an object of certain embodiments to provide a vehicle indicator with increased vibration durability.

It is an object of certain embodiments to provide a vehicle indicator that meets certain minimum photometric requirements.

It is an object of certain embodiments to provide a vehicle indicator that minimizes power requirements.

It is an object of certain embodiments to provide a vehicle indicator that emits light over a relatively narrow frequency range.

Further objects, features and advantages of the embodiments of the present invention shall become apparent from the detailed drawings and descriptions provided herein.

### BRIEF DESCRIPTION OF THE DRAWINGS

FIG. 1 is a perspective view of one embodiment of the present invention.

FIG. 2 is a top cut-away view of the embodiment shown in FIG. 1.

FIG. 3A is a cut-away view along line 3A-3A of FIG. 2.

FIG. 3B is a cut-away view along line 3B-3B of FIG. 2.

FIG. 3C is a cut-away view along line 3C-3C of FIG. 2.

FIG. 4 is a cut-away view along line 4-4 of FIG. 2.

FIG. 5 is an exploded perspective view of the embodiment shown in FIG. 1.

FIG. 6 is a cut-away perspective view of the embodiment shown in FIG. 1 mounted to a semitrailer vehicle.

### DESCRIPTION OF THE SELECTED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

In certain embodiments, the present invention provides a vehicle indicator with side-emitting light-emitting diodes. The side-emitting light-emitting diodes provide vibration resistance, power consumption, heat generation, aesthetic, and spectral transmission advantages over traditional incandescent lamps. One example embodiment includes a side-mounted automobile turn signal indicator. The present invention may be mounted on any vehicle or structure for transporting persons or things, such as powered, unpowered, guided, unguided, manned or unmanned vehicles. Example vehicles include, but are not limited to, automobiles, aircraft, spacecraft, watercraft, trailers, semitrailers, sleds, buggies, and carts. The vehicles are typically operated in proximity to other vehicles with the indicators serving to indicate the vehicle's present, intended, or future position, movement, speed, or acceleration, or any combination thereof. Typically, the vehicle indicators are mounted to the exterior of a vehicle.

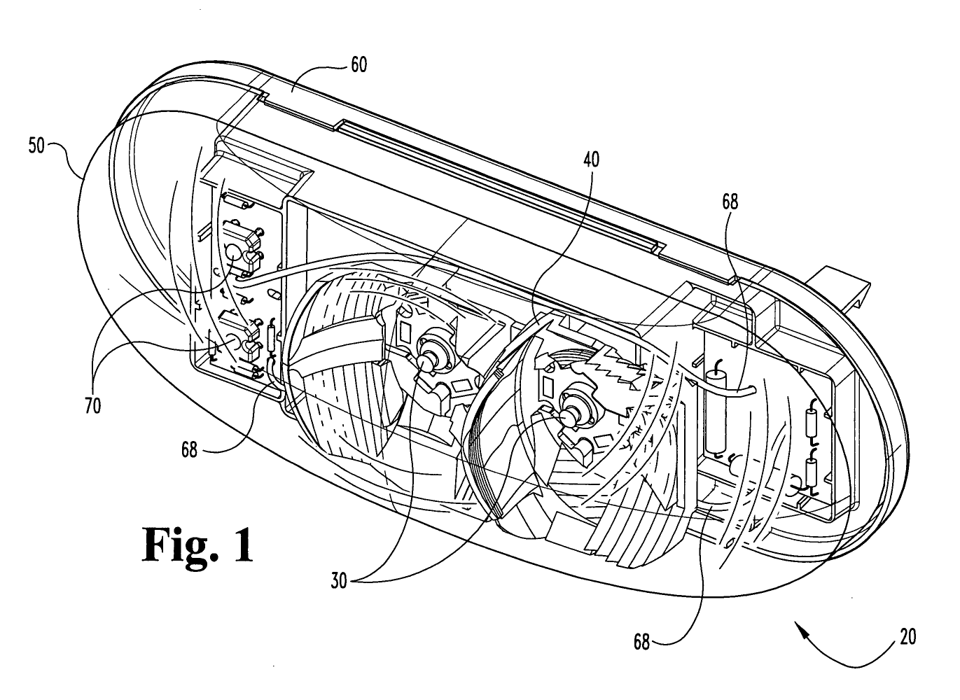

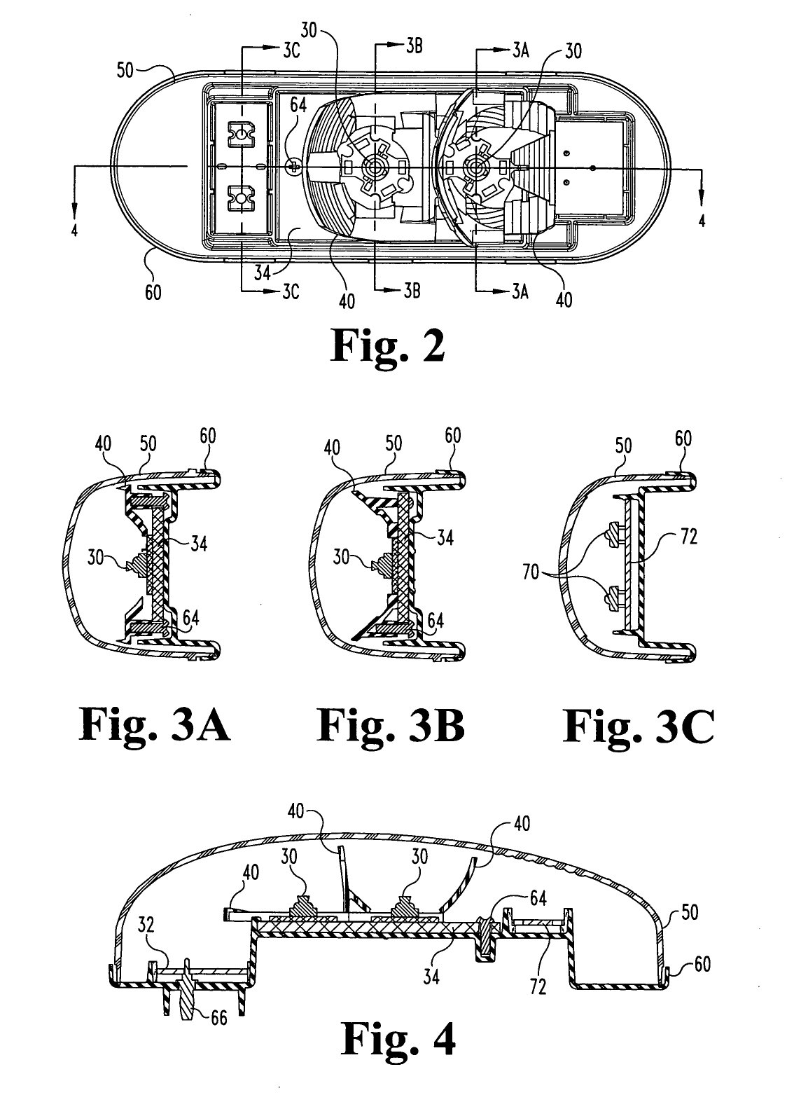

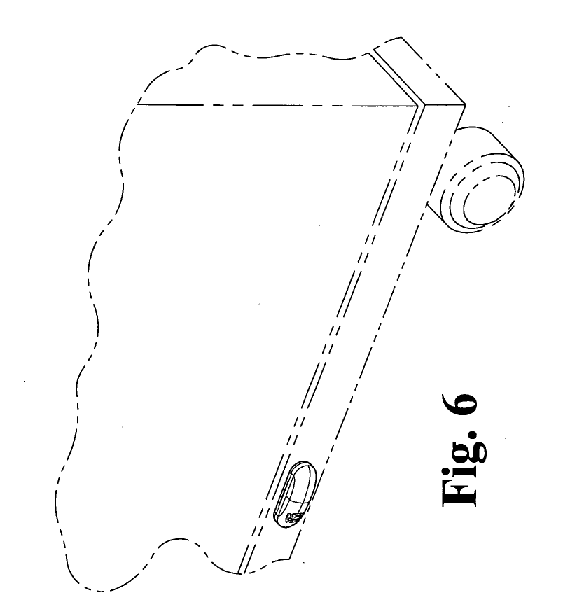

A vehicle indicator 20 according to one embodiment of the present invention is illustrated in FIGS. 1-6. The vehicle indicator 20 is comprised of cover 50 and base 60. Vehicle indicator 20 further includes side-emitting light-emitting diodes 30, electrical wires 68, light-emitting diodes 70, and reflector 40. Cover 50 is attached to base 60 and encloses reflector 40, side-emitting light-emitting diodes 30, light-emitting diodes 70, and all associated circuitry and hardware. Base 60 is connected to vehicle 80 (FIG. 6) utilizing a rubber grommet, although other embodiments do not use a rubber grommet. Vehicle mounting clip 62 is used to assist in attaching electrical terminals 66 to an electrical wiring connector in the vehicle's wiring harness.

Side-emitting light-emitting diodes 30 are thermally connected to heat sink 34 and are electrically connected to electrical wires 68, which are connected to circuit board 32. Circuit board 32 is electrically connected to electrical terminals 66.

Light-emitting diodes 70 are electrically connected to circuit board 72. Circuit board 72 is electrically connected to electrical wires 68, which are electrically connected to electrical terminals 66.

Electrical terminals 66 are electrically connected to corresponding electrical connectors located on the vehicle's structure (not depicted), which are electrically connected to the power source (not depicted), frequently the vehicle's main power source.

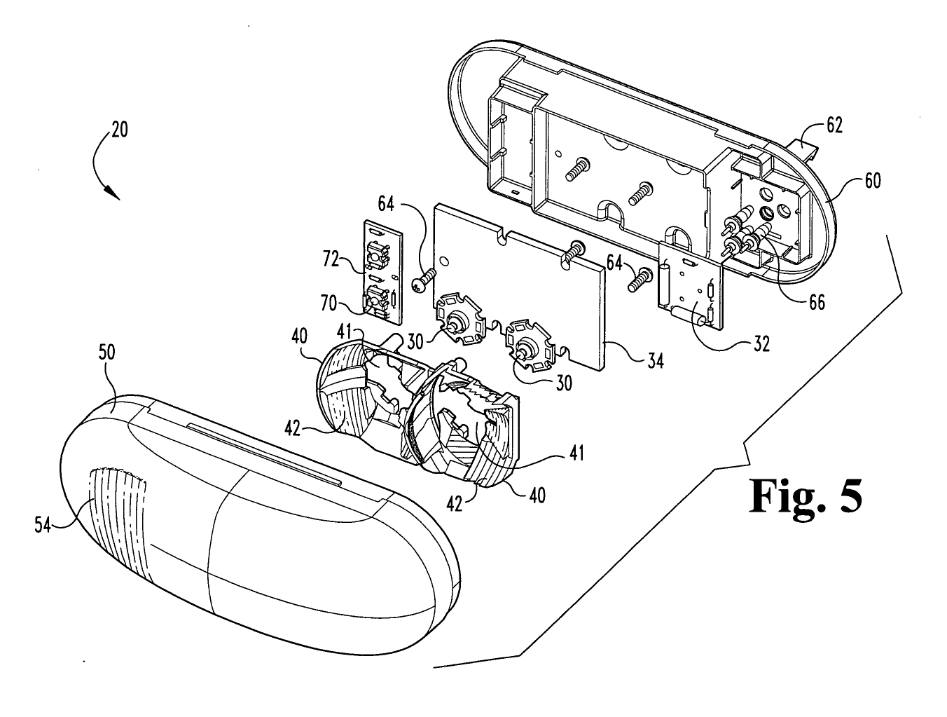

Heat sink 34 is connected to base 60 by attachment hardware 64 (FIG. 5). Heat sink 34 dissipates heat generated by side-emitting light-emitting diodes 30. Reflector 40 is connected to heat sink 34 by attachment hardware 64. When reflector 40 and heat sink 34 are connected, side-emitting light-emitting diodes 30 extend through openings 41 in reflector 40.

In certain embodiments, reflector 40 is a complex reflector containing multifaceted surfaces 42. Multifaceted surfaces 42 each contain a variety of smaller surfaces for reflecting light. The smaller surfaces may have various shapes, such as by way of nonlimiting example, planar, conical, angular, and irregular. The multifaceted surfaces 42 are capable of reflecting light in directions difficult to achieve with smooth surfaces alone. However, other embodiments utilize smooth surfaced reflectors and combinations of smooth and faceted surfaces. Yet other embodiments utilize reflectors with lens portions that allow light to pass through.

A bonding substance, such as a resin or epoxy (not depicted), is used to encase circuit boards 32 and 72, and to encase portions of side-emitting light-emitting diodes 30 with heat sink 34. The bonding substance helps to electrically insulate the circuitry, dissipate heat, and increase the durability of the vehicle indicator 20, especially with respect to vibration. The bonding substance is further useful in protecting the circuitry from damage from objects penetrating cover 50.

The electrical power from the vehicle enters the vehicle indicator 20 through electrical terminals 66. Circuit boards 32 and 72 are electrically connected to electrical terminals 66 and may modify the electrical power to conform with the power requirements of side-emitting light-emitting diodes 30 and light-emitting diodes 70, respectively. Light-emitting diodes 70 are more conventional light-emitting diodes and primarily emit light radially over a portion of the hemisphere located above light-emitting diode 70. Light-emitting diodes 70 receive power from circuit board 72. Side-emitting light-emitting diodes 30 receive power from circuit board 32 and emit light in a predominantly planar fashion. In the depicted embodiment, the central plane of emission for side-emitting light-emitting diodes 30 passes through diodes 30 and is approximately parallel to heat sink 34. Reflector 40 reflects the light emanating from side-emitting light-emitting diodes 30 and focuses the light into the desired directions.

Cover 50 functions to protect the indicator assembly from weather or travel related damage. Cover 50 can also function to influence the indicator's photometric pattern, and/or affect the frequency of light emanating from indicator 20. The portion of cover 50 surrounding reflector 40 allows light emitting from side-emitting light-emitting diodes 30 and reflector 40 to pass through cover 50 relatively unaltered in direction. In contrast, the portion of cover 50 in proximity to light-emitting diodes 70 contains cover lenses 54 (FIG. 5). Cover lenses 54 alters the direction of light emanating from light-emitting diodes 70 and focuses the light into desired directions.

Other embodiments of cover 50 contain portions where the cover is textured, for example, frosted, in order to defussively scatter light emanating from the vehicle indicator 20. Cover 50 may be transparent to the visual or non-visual spectrums and may act as a filter to allow only certain wavelengths to pass through the cover 50. Example visual spectrum wavelengths at which cover 50 may allow light to pass through are red, green, yellow, blue and white. Example non-visible spectrum wavelengths are in the infrared and ultraviolet regions.

One example embodiment of the present invention is a side turn signal indicator that is mounted to a truck trailer (FIG. 6). The side turn signal is placed on the side of the trailer, near the mid-point between the front and rear of the trailer. This position allows operators of other vehicles to see the side turn signal from positions where they cannot see either the front or rear turn signals of the trailer and/or truck.

In use, the truck's operator actuates a turn signal generating device when a change of direction is desired. A timing circuit, either in the turn signal device or the vehicle indicator, varies the amount of electrical power received by vehicle indicator 20, typically in a repeating fashion. Circuit board 32 and circuit board 72 receive these power variations and, as a result, vary the power transmitted to side-emitting light-emitting diodes 30 and light-emitting diodes 70. The power variations result in variations in the light intensity emitted from side-emitting light-emitting diodes 30 and light-emitting diodes 70. In one embodiment, the power variations result in side-emitting light-emitting diodes 30 and light-emitting diodes 70 alternatively illuminating and extinguishing in a repeating fashion. The flashing of vehicle indicator 20 signals to operators of other nearby vehicles that the vehicle's operator intends to turn the vehicle. In other embodiments, circuit board 32 and/or circuit board 72 include timing circuitry to vary the intensity of side-emitting light-emitting diodes 30 and light-emitting diodes 70.

In an alternate embodiment, the variations in power received by vehicle indicator 20 result in side-emitting light-emitting diodes 30 and light-emitting diodes 70 alternating between bright and dim intensity levels. In this situation, the vehicle indicator is continually emitting light; however, the light flashes between a high and low intensity similarly indicating the operator's intention to turn the trailer. This configuration is particularly useful at night when it is advantageous to have side-emitting light-emitting diodes 30 and light-emitting diodes 70 continually emitting light at a minimum level. Certain other embodiments utilize side-emitting light-emitting diodes 30 and light-emitting diodes 70 that are capable of emitting light at a continuous range of intensity levels.

Side-emitting light-emitting diodes 30 and light-emitting diodes 70 may transmit light in the visible and/or non-visible spectrum. Common visible spectrum colors in which the side-emitting light-emitting diodes 30 and light-emitting diodes 70 may transmit are red, green, yellow, blue and white. Typical non-visible spectrum regions in which side-emitting light-emitting diodes 30 and light-emitting diodes 70 may transmit are in the infrared and ultraviolet wavelengths. Emitting light in primarily non-visible spectrums may be particularly useful for certain military applications.

In many instances, vehicle indicators are required to meet particular requirements in order to comply with governmental or private regulations. Nonlimiting example specifications required for side turn indicators for vehicles include The Society for Automotive Engineers (“SAE”) Standard J914, November 1987, SAE Standard J2039, June 1994, and SAE Standard J2039, May 2001. These example specifications require a broad photometric pattern that requires a minimum intensity of light to be emitted over multiple steradians. The SAE J2039, June 1994, standard requires minimum intensity levels at test points ranging from between five degrees from the vehicle's front to five degrees from the vehicle's rear in the horizontal plane, and from fifty degrees up to twenty degrees down in the vertical plane. The SAE J914, November 1987, standard requires minimum intensity levels at test points ranging from between 90 degrees from the vehicle's front to five degrees from the vehicle's rear in the horizontal plane, and from fifteen degrees up to fifteen degrees down in the vertical plane. Other specifications may require different test points and/or minimum intensity levels. The combination of side-emitting light-emitting diodes 30, light-emitting diodes 70, and reflector 40 allow the vehicle indicator 20 to meet the requirements of these example specifications as well as other specifications.

Various types of power sources may be utilized with vehicle indicator 20, such as either AC or DC current. However, conversion to DC power is frequently required for side-emitting light-emitting diodes 30. Example power sources are dry or wet cell batteries, rechargeable batteries, solar cells, or generators. The power may be derived from the vehicle's main power supply system or may be derived from the indicator's own power source.

Materials preferable for constructing the indicator are those which possess vibration, weather and impact resistance. Cover 50 and reflector 40 are typically constructed of material that does not readily change its optical properties (transmissivity or reflectivity) under typical weather conditions such as sunlight, rain or snow. Reflector 40 may be constructed of any reflective material, such as plastic or metal. Cover 50 may be constructed of any material with appropriate optical transmission characteristics such as plastic or glass; however, plastic material less susceptible to shattering than glass is frequently preferred. Base 60 is constructed of any sufficiently durable material, such as plastic, metal or composite material. The material utilized for constructing circuit boards 32 and 72 is typical of standard circuit boards, and common electrical devices, such as capacitors, resistors and transistors and means of connecting them, such as soldering, are typically utilized.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An apparatus for indicating the state of a vehicle, comprising:
a housing mountable to a vehicle; and
a first side-emitting light-emitting diode mounted to said housing.

2. The apparatus of claim 1, further comprising a reflector, wherein said reflector reflects the light emanating from said first side-emitting light-emitting diode.

3. The apparatus of claim 2, wherein said reflector is multifaceted.

4. The apparatus of claim 1, further comprising a power source in electrical communication with said first side-emitting light-emitting diode.

5. The apparatus of claim 1, wherein said apparatus emits light in a pattern ranging between five degrees from the vehicle's front to five degrees from the vehicle's rear in the vehicle's horizontal plane, and ranging between 50 degrees up to 20 degrees down in the vehicle's vertical plane.

6. The apparatus of claim 5, wherein said apparatus emits light in a pattern ranging between 90 degrees from the vehicle's front to five degrees from the vehicle's rear in the vehicle's horizontal plane, and ranging between 15 degrees up to 15 degrees down in the vehicle's vertical plane.

7. The apparatus of claim 1, further comprising a second side-emitting light-emitting diode mounted to said housing.

8. The apparatus of claim 1, further comprising a conventional light-emitting diode mounted to said housing, wherein said conventional light-emitting diode primarily emits light radially over a portion of the hemisphere located above said light-emitting diode.

9. The apparatus of claim 1, wherein said first side-emitting light-emitting diode emits light primarily in the visible electromagnetic spectrum.

10. The apparatus of claim 9, wherein said first side-emitting light-emitting diode emits light primarily in the yellow visible electromagnetic spectrum.

11. The apparatus of claim 1, further comprising a cover.

12. The apparatus of claim 11, wherein said cover is primarily transparent in the visible electromagnetic spectrum.

13. The apparatus of claim 12, wherein said cover is primarily transparent in the yellow visible electromagnetic spectrum.

14. The apparatus of claim 1, wherein said first side-emitting light-emitting diode transmits light at two intensity levels.

15. The apparatus of claim 1, further comprising circuitry, wherein said circuitry provides for alternating illumination intensity levels of said first side-emitting light-emitting diode.

16. A method for indicating the status of a vehicle, comprising:
mounting a side-emitting light-emitting diode to a vehicle; and
powering the side-emitting light-emitting diode.

17. The method of claim 16 further comprising protecting the side-emitting light-emitting diode from weather or travel conditions.

18. The method of claim 16 further comprising reflecting the light emitted from the side-emitting light-emitting diode.

19. The method of claim 18, wherein said reflecting utilizes a multifaceted reflector.

20. The method of claim 16 further comprising focusing the light emitted from the side-emitting light-emitting diode.

21. The method of claim 20, wherein said focusing utilizes a transparent lens.

22. The method of claim 16 further comprising filtering the light emitted from the side-emitting light-emitting diode.

23. The method of claim 22, wherein said filtering primarily allows visual electromagnetic spectrum light to pass.

24. The method of claim 23, wherein said filtering primarily allows yellow visual electromagnetic spectrum light to pass.

25. An apparatus, comprising:
a vehicle; and
means for indicating the state of a vehicle, wherein said means includes a side-emitting light-emitting diode.

26. The apparatus of claim 25, further comprising means for protecting the side-emitting light-emitting diode from weather or travel conditions.

27. The method of claim 25 further comprising means for reflecting the light emitted from the side-emitting light-emitting diode.

28. The method of claim 25 further comprising means for powering the side-emitting light-emitting diode.

29. The method of claim 25 further comprising means for focusing the light emitted from the side-emitted light-emitting diode.

30. The method of claim 25 further comprising means for filtering the light emitted from the side-emitted light-emitting diode.
